(19) United States
(12) Patent Application Publication
(10) Pub. No.: US 2023/0311443 A1
(43) Pub. Date: Oct. 5, 2023

(54) AN EMBOSSED WRAPPING MATERIAL

(71) Applicant: Storopack Hans Reichenecker GMBH, Metzingen (DE)

(72) Inventors: Paul Deis, Preuschdorf (FR); Jean-Marc Slovencik, Rosenfeld (DE)

(21) Appl. No.: 18/004,155

(22) PCT Filed: Feb. 19, 2021
(86) PCT No.: PCT/EP2021/054167

§ 371 Date: Jan. 3, 2023

(30) Foreign Application Priority Data
Jul. 15, 2020 (EP) 20 186 026.9

(51) Int. Cl. B31D 5/00; B65D 81/03; B31F 1/07; B31F 1/10

(52) U.S. Cl. CPC B31D 5/006; B65D 81/03; B31F 1/07; B31F 1/10; B31D 5/0052; B31F 2201/0733; B31F 2201/0738; B31F 2201/0797

(57) ABSTRACT

An embossed wrapping material for protectively cushioning an article comprises a plurality of embossed protrusions, wherein the plurality of embossed protrusions comprises first protrusions, extending in a first direction and second protrusions extending in a second direction, the second direction being opposite to the first direction. At least regionally the embossed wrapping material comprises a plurality of first creases created during or prior to embossing the protrusions.

The invention relates to an embossed wrapping material comprising a plurality of embossed protrusions.

It is known to protect objects to be transported or shipped from impacts or other harmful external influences by wrapping these objects with a cushioning material. Such a cushioning material can be, for example, a bubble wrap made of plastic, or another three-dimensional cushioning material, which for example has bulges similar to an egg carton. It is also known to protect fruits and vegetables in a kind of an egg carton.

International patent publication WO 2019/020631 A1 discloses a wrapping paper material for packaging purposes having a cushioning portion comprising a plurality of convex protrusions and concave recesses. Similar wrapping materials are disclosed in DE 1 894 663 U, DE 1 675 907 U, and U.S. Pat. No. 3,288,353 A. It is a known technique for producing this type of wrapping paper material by providing a plurality of embossments to an initially flat web type paper material. In order to prevent the paper material from cracking when creating the embossments, the paper material is treated by hot steam prior to the embossing step such that it becomes more elastic and soft. Furthermore, DE 195 09 863 A1 discloses a method for producing a packaging product for drugs or sweets having protrusions into which a drug or a sweet can be placed, similarly to an egg carton.

It is an object of the present invention to provide an embossed wrapping material consuming less energy during production and being less complicated to produce.

The above-mentioned and other objects are achieved by means of an embossed wrapping material having the features of the independent claims. Advantageous further embodiments are described in dependent claims.

With the inventive embossed wrapping material it is no more necessary to pretreat the raw material by means of hot steam prior to creating the embossed protrusions (embossments). By consequence, less energy is needed for the production of the embossed wrapping material, and an arrangement for producing the embossed wrapping material is less complicated and more economical. Furthermore, the embossed wrapping material itself has superior cushioning properties because its stiffness is not weakened by applying hot steam during the manufacturing process. These advantages are achieved by transferring a technology, which is known from the production of blister packs for drugs and inlets for boxes for sweets such as confection or cookies, to wrapping material.

According to the invention the surplus of material necessary for embossing the protrusions without risking to create cracks or ruptures, respectively, during the embossing step is provided by means of a plurality of undulations present in the material prior to embossing the protrusions. Those undulations which are not or not entirely consumed for creating the protrusions are pressed during the embossing step into said first creases which remain visible at the finished embossed wrapping material. By having first protrusions extending in a first direction and second protrusions extending in a second direction, the second direction being opposite to the first direction, the thickness of the wrapping material is increased and thus the material needed for wrapping an article such that it is protectively cushioned is considerably reduced.

It is particularly preferred that the undulations in the material which are created prior to the embossing step and which are the basis for the first creases and which allow to create the embossed protrusions without material rupture reduce a first dimension of the initially flat paper material by approximately 20-60%, more preferably by approximately 40-50%. These parameters have proven to be the best compromise between the provision of a sufficient surplus of material and minimum consumption of material for creating said surplus.

In a further embodiment at least one lateral edge region comprises a higher number of material layers than a central region. This reinforces the lateral edge region which increases the stability of the embossed wrapping material.

In a further embodiment the lateral edge region is formed by at least one 180° fold of the material layer(s) extending from the central region. This is a simple method for obtaining the reinforced lateral edge region.

In a further embodiment a width of the lateral edge region corresponds to at least the width of a protrusion. This has proven to be sufficient for increasing the stability of the inventive wrapping material.

In a further embodiment the lateral edge region also comprises protrusions. This means that the protrusions are embossed at least partially into the multiple layers of the lateral edge region, which further stabilizes the lateral edge region and maximizes the functionally active cushioning region of the wrapping material.

In a further embodiment the wrapping material comprises at least one longitudinally extending strip shape region which is free of protrusions and which is delimited on both sides by regions with protrusions. Such a longitudinally extending strip shape region allows to place a separating or deflector means, respectively, after an embossing cylinder during manufacturing the inventive wrapping material at the lateral location of the strip shape region, such that sticking of the embossed wrapping material to the embossing cylinder can be prevented without damaging the embossed material, that is without the separating means interfering with embossed protrusions.

In a further embodiment the width of the strip shape region corresponds to at least the width of a protrusion. This has proven to be a width which allows to separate the embossed material from the embossing cylinder without damaging the product.

In a further embodiment the wrapping material is initially formed as a lengthy web comprising crosswise extending perforation lines, the perforation lines being formed by material bridges alternating with material slits, the material slits being located between the material bridges, at least some of the material slits being at least 15 times longer than at least some of the material bridges, more preferably at least 30-50 times longer than the material bridges. This type of perforation may be cut into the flat material prior to the creasing and embossing steps. It is, however, preferred to cut the perforation into the final product after the creasing and embossing steps. The proposed perforation provides for a sufficient stability of the web-type material, but allows a user to easily separate individual sheets of embossed cushioning material from the web material without damaging the protrusions and according to the actual wrapping needs.

In a further embodiment the length of the material bridges is in the range of approx. 0.3-1.5 mm, preferably approx. 0.5 mm. These values have proven to be particularly suitable for obtaining the above-mentioned advantages. In a further embodiment a height of at least some of the protrusions is in the range of 4-45 mm, more preferably in the range of 4-18 mm, still more preferably in the range of 4-7 mm. These parameters have proven to be the best compromise between the provision of an optimum cushioning effect and a minimum requirement for surplus material.

In a further embodiment the embossed wrapping material at least regionally comprises a plurality of second creases created during or prior to embossing the protrusions, the second creases being essentially orthogonal to the first creases. The second creases may result from a crumpling action to the material prior to embossing the protrusions which additionally makes available a surplus of material allowing to embossed the protrusions without material rupture.

It is particularly preferred embodiments the crumpling action applied to the material prior to the embossing step reduces a second dimension of the initially flat paper material by approximately 5-20%, more preferably by approximately 10-15%, the second dimension being essentially orthogonal to the above mentioned first dimension. These parameters have proven to be the best compromise between the provision of a sufficient surplus of material and minimum consumption of material for creating said surplus.

In a further embodiment the embossed protrusions have a maximum transverse dimension, when viewed from above, in the range of 4-100 mm, more preferably in the range of 10-18 mm, still more preferably in the range of 12-16 mm. These parameters have proven to be the best compromise between the provision of an optimum cushioning effect and a minimum requirement for surplus material.

In a further embodiment the embossed wrapping material comprises first embossed protrusions having at least a first value of a dimension and second embossed protrusions having at least a second value of the same dimension, wherein the first value is different than the second value. More specifically, the embossed wrapping material may comprise embossed protrusions differing from each other in the height and/or the transverse dimension. This allows to more specifically adapt the wrapping material to the individual cushioning needs.

In a further embodiment the grammage of the initially flat paper material is in the range of approximately 40-80 g/m², more preferably in the range of approximately 60-70 g/m². These parameters have proven to provide a sufficient stiffness to the wrapping material which is necessary to protect heavy objects wrapped by the wrapping material, but still allow to easily create the undulations and to emboss the protrusions.

In a further embodiment a density of embossed protrusions (number of protrusions per area) is in the range of approximately 3000-6000 1/m², more preferably in the range of approximately 4000-5500 1/m², still more preferably in the range of approximately 4300-5300 1/m². It is to be understood that these values only relate to areas where protrusions are present and do not include areas of the wrapping material which are free of protrusions. These parameters have proven to be the best compromise between the provision of an optimum cushioning effect and a minimum requirement for surplus material.

In a further embodiment a cross sectional shape, when viewed from the side, of at least some of the embossed protrusions is approximately half-circular, rectangular, or trapezoid. Such protrusions easily can be embossed.

In a further embodiment a cross sectional shape, when viewed from the side, of at least some of the embossed protrusions is dome-shaped with a raising bottom portion and an essentially flat top portion extending essentially parallel to a reference plane of the wrapping material. This three-dimensional shape of the embossed protrusions has shown improved resistance and stability against crushing by applying a force against a rotational or middle axis of a protrusion. By consequence, the embossed wrapping material provides improved cushioning properties.

In a further embodiment the raising bottom portion comprises a first portion adjacent a reference plane of the wrapping material and an intermediate second portion arranged between the first portion and the top portion, wherein the slope “suddenly” changes at the transition of the first portion to the intermediate second portion. The intermediate second portion and the top portion form a resilient entity providing a first cushioning effect, whereas the first portion adjacent the reference plane of the wrapping material provides a certain stiffness and will be crushed only after the intermediate second portion has been crushed.

It is to be understood that the term “suddenly” is not limited to a sharp rim but may be understood functionally in that the transition is formed by a region having a sensibly more important curvature than the regions adjacent to the transition. The dome-shaped cross sectional shape of the protrusions provides for a two-stage crushing resistance of the protrusions and an improved elasticity of the protrusions prior to being crushed. It is to be understood that this advantage may also be achieved with a wrapping material which does not comprise the plurality of first creases created during or prior to embossing the protrusions.

In a further embodiment a cross sectional shape, when viewed from above, of at least some of the embossed protrusions is approximately circular, oval, or polygonal, specifically hexagonal. Such protrusions easily can be embossed.

In a further embodiment the embossed wrapping material comprises craft paper, preferably recycled craft paper. Craft paper, and especially recycled craft paper have an advantageous ecological footprint.

The invention now will be described with reference to the attached drawing. In the drawing is

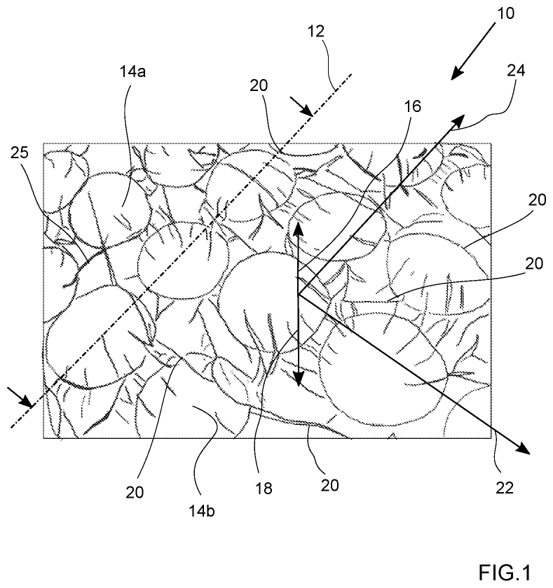

FIG. 1 a perspective partial view of first embodiment of an embossed wrapping material comprising embossed protrusions and a plurality of first creases;

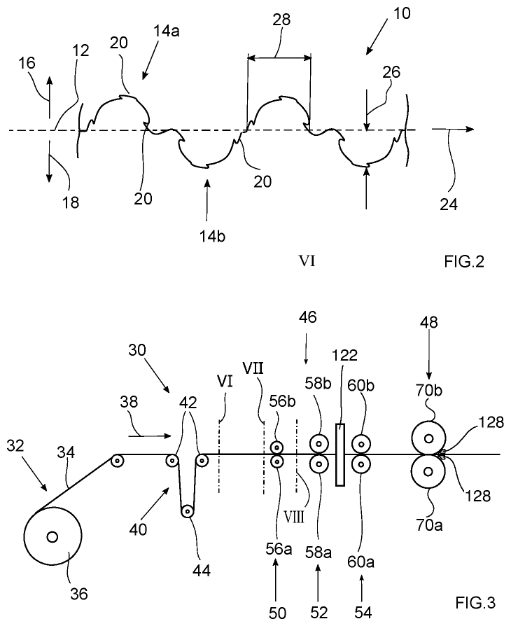

FIG. 2 a schematic sectional view along line II-II of FIG. 1;

FIG. 3 a schematic side view of an arrangement for producing the embossed wrapping material of FIGS. 1 and 2;

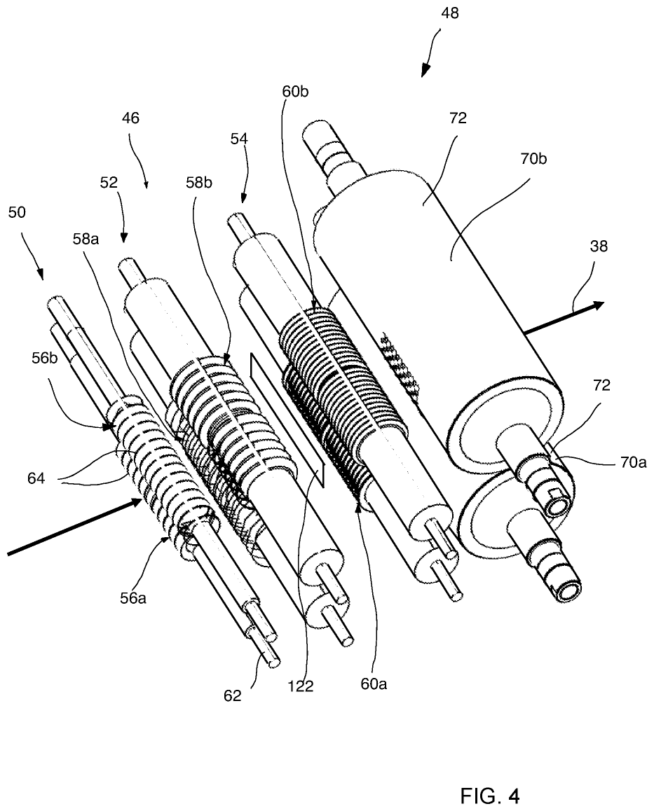

FIG. 4 a perspective view of an undulating device and an embossing device of the arrangement of FIG. 3;

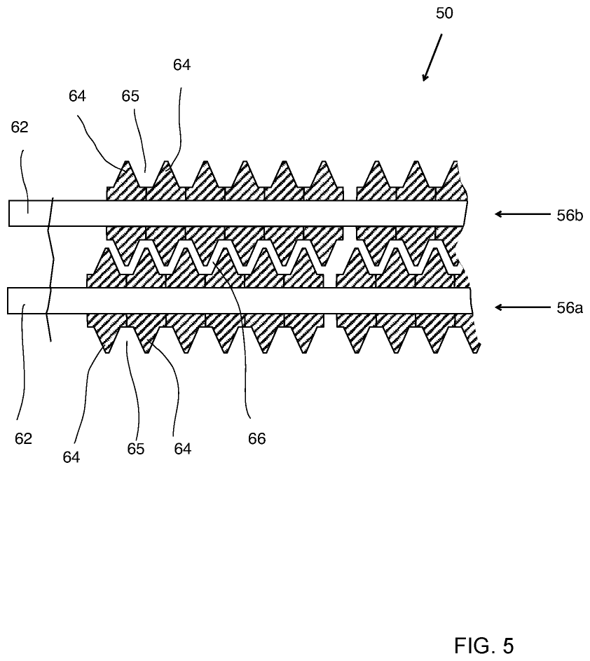

FIG. 5 a partial sectional view through a first undulating unit of the undulating device of FIG. 4;

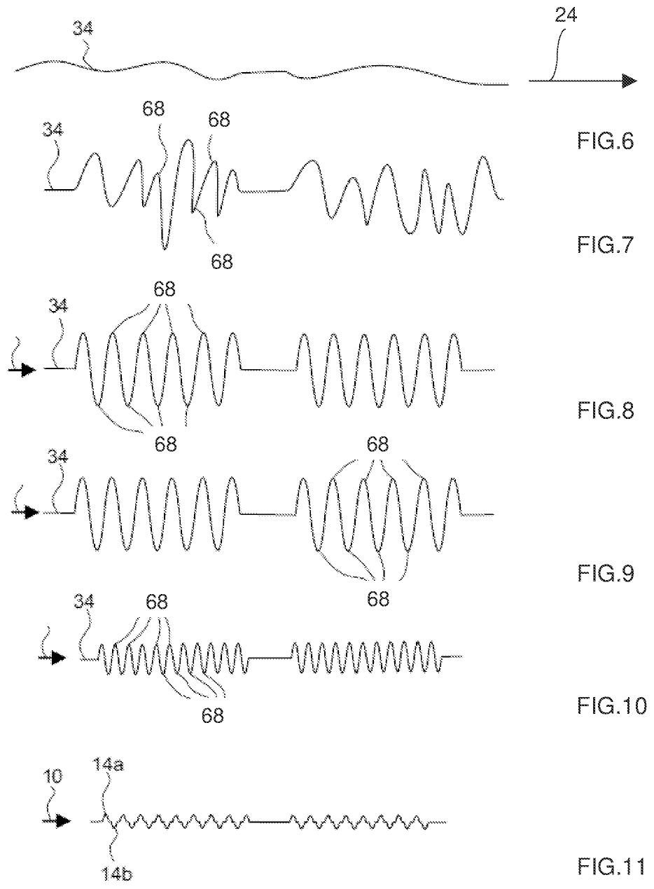

FIGS. 6-11 schematic sectional representations of the shape of a paper material at different positions during its way through the arrangement of FIG. 3 according to lines VI to XI of FIG. 3;

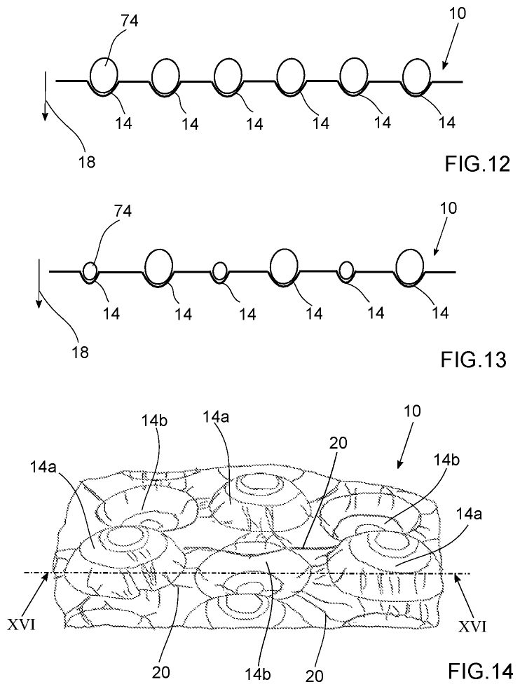

FIG. 12 a schematic sectional view similar to FIG. 2 of an embossed cushioning material;

FIG. 13 a schematic sectional view similar to FIG. 12 of a further alternative embodiment of an embossed cushioning material;

FIG. 14 a perspective partial view similar to FIG. 1 of a second embodiment of an embossed wrapping material;

FIG. 15 an enlarged perspective view of an embossed protrusion of the embossed wrapping material of FIG. 14;

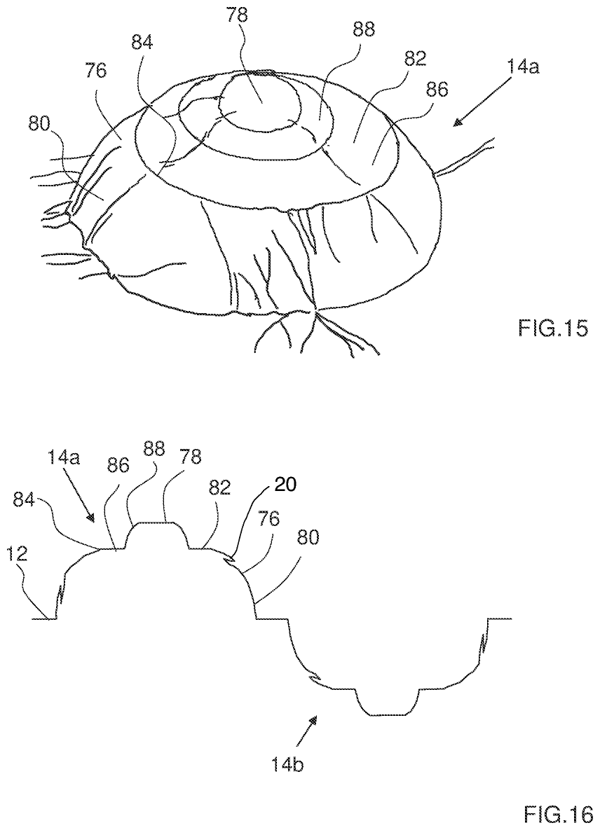

FIG. 16 a schematic sectional view along line XVI-XVI of FIG. 14;

FIG. 17 a sectional view through a peripheral surface of an embossing cylinder and an embossing element for manufacturing the wrapping material of FIG. 14;

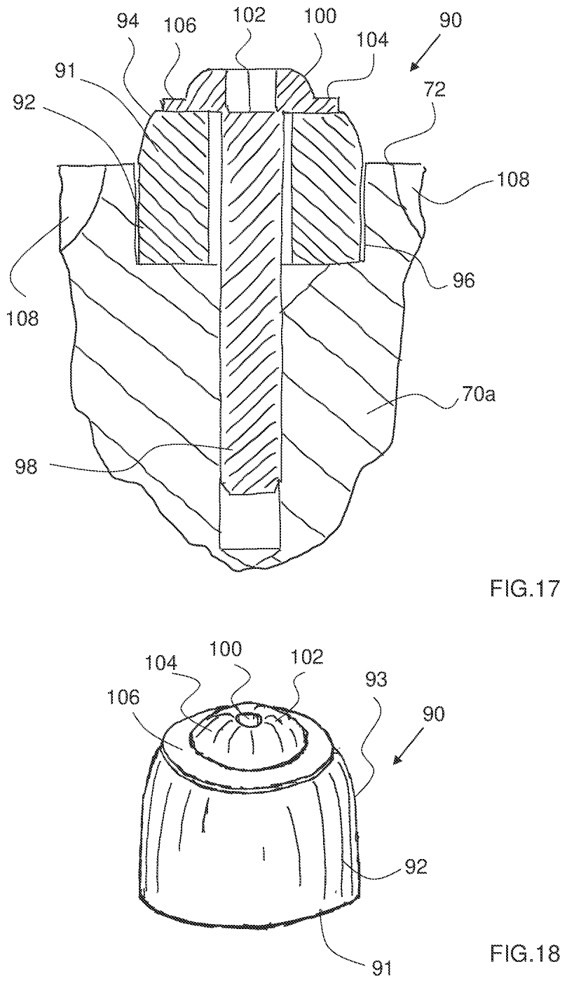

FIG. 18 a perspective view of the embossing element of FIG. 17;

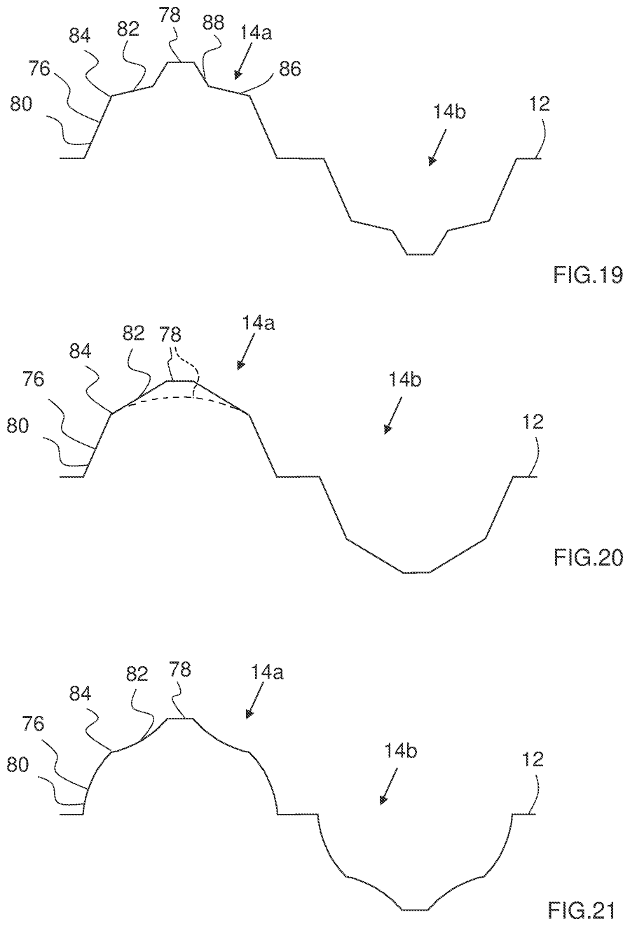

FIG. 19 a schematic sectional view similar to FIG. 16 of a still further embodiment;

FIG. 20 a schematic sectional view similar to FIG. 19 of a still further embodiment;

FIG. 21 a schematic sectional view similar to FIG. 20 of a still further embodiment;

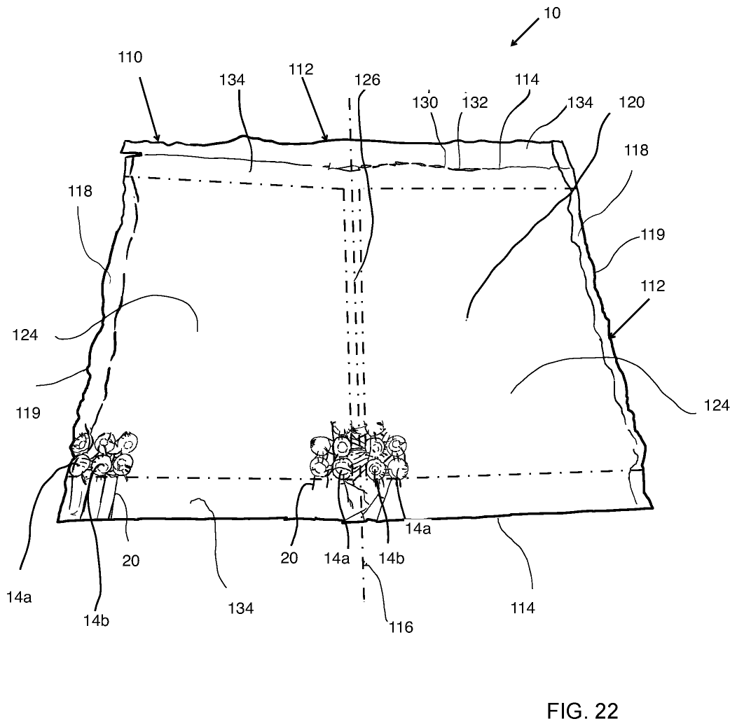

FIG. 22 a schematic perspective view of a further embodiment of an embossed wrapping material; and

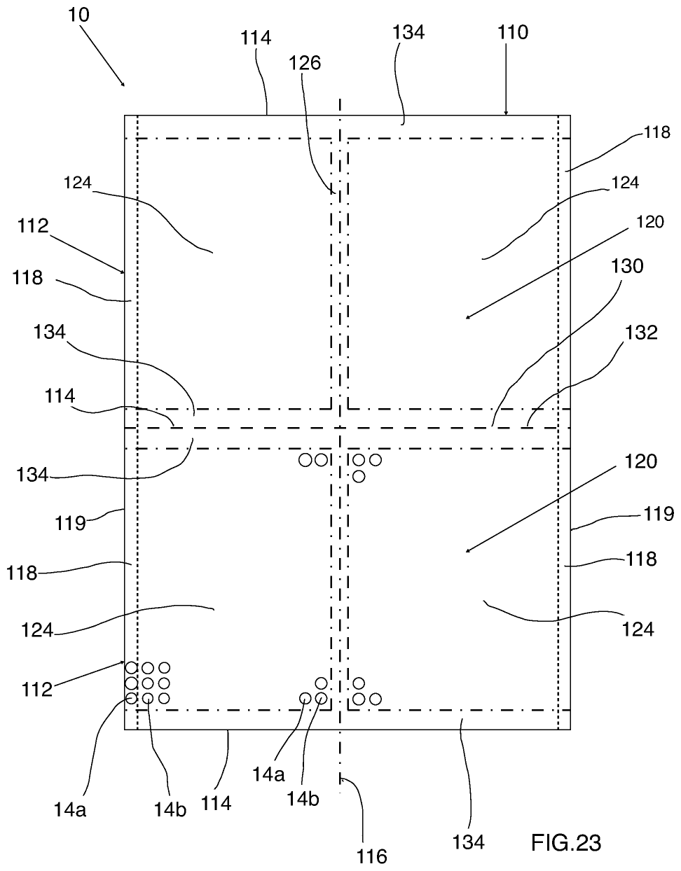

FIG. 23 a plain view onto the embossed wrapping material of FIG. 22.

It is to be noted that for the sake of clarity in the figures only exemplary but not all elements and portions or regions are designated with reference signs. Furthermore, functionally equivalent elements and portions in different embodiments have the same reference signs.

In the figures, an embossed wrapping material generally has the reference sign 10. As can be seen from FIGS. 1 and 2, the embossed wrapping material 10 is generally flat with a reference or middle plane 12. It comprises a plurality of first embossed protrusions 14a and a plurality of second embossed protrusions 14b. The first embossed protrusions 14a extend from the reference or middle plane 12 in a first direction 16. The second embossed protrusions 14b extend from the reference or middle plane 12 in a second direction 18, the second direction 18 being opposite to the first direction 16. Both directions 16 and 18 are orthogonal to the reference or middle plane 12. The positions of the first embossed protrusions 14a and the second embossed protrusions 14b are arranged in an alternating order which means that in a row of protrusions adjacent to a first embossed protrusion 14a there are two second embossed protrusions 14b.

The embossed wrapping material 10 further comprises a plurality of first creases 20. As can be seen especially from FIG. 1, the generally flat embossed wrapping material 10 has a longitudinal direction 22 and a lateral direction 24. The first creases 20 essentially extend parallel to the longitudinal direction 22, which is the direction orthogonally to the drawing plane of FIG. 2.

The embossed wrapping material 10 further comprises a plurality of second creases 25. The second creases 25 essentially extend parallel to the lateral direction 24.

In the present exemplary embodiment the embossed wrapping material 10 is made from craft paper. It is particularly preferred that the embossed wrapping material 10 is made from recycled craft paper. The grammage of the initially flat craft paper material is in the range of approximately 40-80 g/m², more preferably in the range of approximately 60-70 g/m².

In the present exemplary embodiment a cross sectional shape, when viewed from the side (FIG. 2), of the embossed protrusions 14a and 14b is approximately half-circular. In other non-shown embodiments the cross sectional shape may be essentially rectangular or essentially trapezoid. Furthermore, in the present exemplary embodiment a cross sectional shape, when viewed from above (FIG. 1), of the embossed protrusions 14a and 14b is approximately circular. In other non-shown embodiments the cross sectional shape may be oval or polygonal, specifically hexagonal.

In the present exemplary embodiment of FIGS. 1 and 2 the embossed wrapping material 10 is intended to be used for protectively wrapping an article. In this case, a height 26 (FIG. 2) of the protrusions 14a and 14b is in the range of 4-18 mm, more preferably in the range of 4-7 mm. Furthermore, in the present exemplary embodiment the embossed protrusions 14a and 14b have a maximum transverse dimension 28, when viewed from above (along first and second directions 16 and 18, see FIG. 2), of approximately 10-18 mm, more preferably of approximately 12-16 mm. Furthermore, in the present exemplary embodiment a density of the embossed protrusions 14a and 14b, that is the total number of protrusions 14a and 14b per area, is in the range of approximately 4000-5500 1/m², more preferably in the range of approximately 4300-5300 1/m².

In the embodiment of FIGS. 12 and 13 a larger height, for example in the range between 20-45 mm, and a larger transverse dimension, for example in the range between 20-100 mm, than those values indicated above makes the shown embossed cushioning material 10 particularly suitable for at least partially placing food 74 within the cavities provided by the embossed protrusions 14, similar to the principles of an egg carton, rather than for wrapping an article. It is to be understood that the dimensions can be adapted easily to the specific type of food 74 to be placed at least partially within the cavities, and it is possible to create a cushioning material 10 having cavities of different sizes in order to accommodate at least partially food of different sizes in the same cushioning material 10, as is shown in FIG. 13. Furthermore, in this case it is preferred that all embossed protrusions 14 extend only in one direction, for example the second direction 18.

Reference is now made to FIG. 3 showing an arrangement 30 for producing the embossed wrapping material 10. It is to be understood that in FIG. 3 only those components of the arrangement 30 are shown which are particularly important for producing the first and second creases 20 and 25 and the first and second embossed protrusions 14a and 14b of the embossed wrapping material 10. The arrangement 30 may comprise further non-shown components, such as supports, drives, gears, sensors and controllers.

The arrangement 30 comprises a supply 32 for supplying an initially flat and web-type paper raw material 34. The web-type paper raw material 34 may be provided by way of example as a roll 36 of paper. In an alternative non-shown embodiment the flat web-type paper raw material may be provided as a stack of zigzag folded paper. The flat web-type paper raw material 34 is conveyed along a transport path 38 through the arrangement 30.

It first passes a tensioning unit 40 comprising two stationary cylindrical rollers 42 and a vertically movable cylindrical roller 44. The vertically movable cylindrical roller 44 puts the flat web-type paper raw material 34 under a certain tension in the direction of the transport path 38 by its weight. However, the tensioning action of the vertically movable cylindrical roller 44 may be further enhanced for example by a spring forcing the vertically movable cylindrical roller 44 downwardly.

Seen in the direction of the transport path 38 downstream of the tensioning unit 40 an undulating device 46 and an embossing device 48 are arranged. The undulating device 46 comprises three pairs 50, 52 and 54 of cooperating forming devices 56a/b, 58a/b, and 60a/b.

The general designs of the forming devices 56-60 are similar to each other. This general design therefore will be described hereinafter by way of example with reference to the forming devices 56a/b of the first pair 50 (FIGS. 4 and 5).

The forming device 56a comprises a shaft 62 on which is arranged a plurality of disk type conically shaped portions 64. The disk type portions 64 are spaced apart from each other and arranged along a longitudinal axis of the shaft 62 such that interstices 65 are formed between adjacent disk type portions 64. The disk type portions 64 of the first forming device 56a mesh with interstices 65 between the disk type portions of the second forming device 56b, the interstices 65 formed between the meshing disk type portions 64 of the forming devices 56a and 56b forming an undulated space 66 creating undulations of the initially flat web-type paper raw material 34 when it passes between the first and the second forming devices 56a and 56b.

FIG. 6 is a schematic sectional view of the still flat web-type paper material 34 seen in the direction of the transport path 38 shortly after the tensioning unit 40. FIG. 7 is a schematic sectional view of the web-type paper material 34 seen in the direction of the transport path 38 shortly before the first pair 50 of forming devices 56a/b, and FIG. 8 is a schematic sectional view of the web-type paper material 34 seen in the direction of the transport path 38 shortly after the first pair 50 and prior to entering the second pair 52 of forming devices 58a/b. As can be seen from FIGS. 6-8, the first pair 50 of the cooperating forming devices 56a and 56b reduces a first lateral dimension which is parallel to the lateral direction 24 of the initially flat paper material 34 by approximately 40% by creating a plurality of undulations 68.

As can be seen from FIG. 4, the forming devices 58a and 58b of the second pair 52 have a larger diameter than those of the first pair 50 which helps to homogenize and stabilize the undulations 68, as can be seen from FIG. 9 which is a schematic sectional view of the now undulated web-type paper material 34 seen in the direction of the transport path 38 shortly after the second pair 52 and prior to entering the third pair 54.

As can be seen from FIG. 4, the forming devices 60a and 60b of the third pair 54 have approximately the same diameter as those of the second pair 52. However, the disk type portions (without reference signs) are slimmer than those of the second pair 52 such that a higher number of disk type portions is arranged along the shafts of the forming devices 60a and 60b. Furthermore, the depth of the interstices between the disk type portions is smaller than that of the first and second pair 50 and 52.

As can be seen from FIG. 10, which again is a schematic sectional view of the undulated web-type paper material 34 seen in the direction of the transport path 38 shortly after the first pair 54 and prior to entering the embossing device 48, the third pair 54 increases the number of undulations 68 while reducing the height of these undulations 68.

After the web-type paper material 34 has passed the undulating device 46 and after having been transformed into an undulated web-type paper material 34 it enters the embossing device 48 which comprises two rotating and driven embossing cylinders 70a and 70b. The embossing cylinders 70a and 70b are designed and arranged to receive the undulated paper material 34 therebetween. Both embossing cylinders 70a/b have a peripheral surface 72 comprising a plurality of protrusions and recesses creating the embossed protrusions 14a and 14b as described above with reference to FIGS. 1 and 2 when the undulated web-type paper material 34 is received between the embossing cylinders 70a and 70b. It is to be understood that the protrusions in the peripheral surfaces 72 of the embossing cylinders 70a and 70b mesh with complementary recesses in the respective other embossing cylinder 70a and 78b.

A schematic sectional view of the embossed wrapping material 10 downstream of the embossing device 48 seen in the direction of the transport path 38 is shown in FIG. 11.

It is to be understood that the undulations 68 of the undulated web-type paper material 34 as shown in FIG. 10 provide a surplus of material which allows to emboss the first protrusions 14a and the second protrusions 14b by means of the embossing cylinders 70a and 70b without rupture of the material. Since the gap between the embossing cylinders 70a and 70 is very small, preferably only slightly bigger than the thickness of the flat web-type paper raw material 34 as enrolled on the roll 36, those undulations 68 which are not or not fully consumed for creating the first and second protrusions 14a and 14b are transformed, namely pressed into the first creases 20 as shown in FIGS. 1 and 2.

As can be seen from FIGS. 1 and 2 the first creases 20 have been created prior to or during embossing the first and second protrusions 14a and 14b since they are extending into all regions of the embossed material and since they are located and arranged within the thin layer of the paper material. This would not be possible if the first creases were created only after the first and second protrusions 14a/b have been embossed.

The forming devices 56a-60b of the pairs 50-54 of the undulating device 46 and the embossing cylinders 70a/b of the embossing device 48 are driven with specific rotational speeds. The rotational speeds of the forming devices 56-60 are selected such that the web-type paper raw material 34 is conveyed through the undulating device 46 with a uniform speed in the direction of the transport path 38.

In contrast hereto, the rotational speeds of the embossing cylinders 70a and 70b on the one hand and the rotational speeds of the forming devices 60a/b of the third pair 54 on the other hand are selected such that the undulated web-type paper material 34 is conveyed through the embossing device 48 along the transport path 38 at a lower speed than through the undulating device 46. This results in a crumpling action applied to the undulated web-type paper material 34 in longitudinal direction 22, which extends parallel to the direction of the transport path 38.

The crumpling action results in a reduction of the dimension of the undulated web-type paper material 34 in the longitudinal direction 22 by approximately 10%. The reduction of the dimension of the undulated web-type paper material 34 in the longitudinal direction 22 results in the creation of second undulations which are pressed by the embossing cylinders 70a/b into the above mentioned second creases 25. The second creases 25 extend essentially orthogonally to the first creases 20.

It is to be understood that the web-type paper material may be single ply material or a double or multiple ply material. Furthermore, in the case that the web-type paper material is a double or multiple ply material, at least one of the plies may primarily provide the cushioning properties while another of the plies may primarily provide an optical property.

Now, reference is made to FIGS. 14-16 which relate to a second embodiment of an embossed wrapping material 10. The embossed wrapping material 10 of FIGS. 14-16 is different from that of FIGS. 1-2 by the cross sectional shape of the embossed protrusions 14a and 14b. The embossed protrusions 14a and 14b of the embodiment of FIGS. 14-16 have a cross sectional shape, when viewed from the side, which is dome-shaped with a raising bottom portion 76 and an essentially flat top portion 78. It is to be noted that the term “flat” in this context does not mean that this portion must be totally straight, but that its average angle relative to the reference plane 12 of the wrapping material 10 is considerably lower than an average angle of the raising bottom portion 76, with an area of a sudden change of angle defining a kind of rim somewhere between both portions 76 and 78.

The raising bottom portion 76 comprises a first portion 80 which is adjacent the reference plane 12 of the wrapping material 10 and an intermediate second portion 82 which is arranged between the first portion 80 and the top portion 78. As can be seen for example from FIGS. 15 and 16, a rim 84 may be formed between the first portion 80 and the intermediate second portion 82. Or, in other words: a slope of the wall of the embossed protrusion 14a/14b suddenly changes at the transition from the first portion 80 to the intermediate second portion 82 formed by the rim 84. It is to be understood that the terms “suddenly” and “rim”, respectively, are to be understood functionally in that the transition from the first portion 80 to the intermediate second portion 82 is formed by a region having a sensibly more important curvature than the regions adjacent the transition.

In the specific embodiment of FIGS. 14-16, the intermediate second portion 82 comprises two sections 86 and 88 which are ring shaped when viewed from above. While the first ring shaped section 86, which is adjacent the first portion 80 of the raising bottom portion 76, is relatively flat, that is more or less parallel to the reference plane 12, the second ring shaped section 88, which is adjacent the flat top portion 78, raises diagonally upwards and inwards in an axial direction of the embossed protrusions 14a/14b.

For embossing the protrusions 14a/14b of FIGS. 14-16, an embossing element 90 is used as shown in FIGS. 17 and 18. The embossing element 90 comprises a sleeve 91 having a straight cylindrical outer surface portion 92 and a curved cylindrical outer surface portion 94. The outer surface portion 94 is curved inwardly towards a middle axis (not shown) of the sleeve 91. In the embossing cylinder 70a a cylindrical recess 96 is provided having a depth which corresponds essentially to the length of the surface portion 92 of the sleeve 91.

The sleeve 91 is arranged within the cylindrical recess 96 such that it protrudes out of the cylindrical recess 96 with its inwardly curved cylindrical outer surface portion 94. The sleeve 91 is fixed to the embossing cylinder 70a by means of a screw 98 having a screw head 100 having a flat top surface 102 which transitions into a curved edge portion 104. A flat ring shaped outer edge portion 106 is unitary with the curved edge portion 104.

Adjacent the embossing element 90, complementary recesses 108 are provided in the peripheral surface 72 of the embossing cylinder 70a in order to receive during manufacturing of the wrapping material 10 the embossing elements 90 fixed to the other cooperating embossing cylinder 70b (not shown in FIG. 17).

FIGS. 19-21 are schematic representations of other exemplary sectional shapes of embossed protrusions 14a/b. In FIG. 19, the wall of the embossed protrusion 14a/b is composed by essentially conical (extending diagonally inwards) and straight wall sections 80, 86, and 88.

The embossed protrusions 14a/b of FIG. 20 are similar to that of FIG. 19, however the intermediate second portion 82 being formed by one single straight wall section extending diagonally inwards towards the flat top portion 78. On the left side of FIG. 20 another alternative embodiment is shown with a dashed line, wherein the essentially flat top portion 78 is formed by a convex dome portion (“convex” when seen from the outside of the protrusion) directly extending from the raising bottom portion 76.

The embossed protrusions 14a/b of FIG. 21 are similar to that of FIG. 20, however the first portion 80 being curved inwardly (concave when seen from the inside of the protrusion) and the intermediate second portion 82 being curved outwardly (convex when seen from the inside of the protrusion).

A particularly preferred embodiment of an embossed wrapping material 10 is now explained with respect to FIGS. 22 and 23. FIG. 23 represents a lengthy web 110 comprising, purely by way of example, two sheets 112 of wrapping material 10 which are linked to each other by means of a crosswise extending perforation line 114 (the upper sheet 112 is only partially shown in FIG. 22). A longitudinal axis of the web 110 is drawn in both figures by a dot and dash line 116. Each of the sheets 112 comprises, when seen along the longitudinal axis 116, a left lateral edge region 118 and a right lateral edge region 118. The boundary of the edge regions 118 towards a central region 120 is drawn as a dotted line in FIG. 23. By consequence, the central region 120 extends between both edge regions 118. This means that the central region 120 is delimited in FIG. 23 by the two lateral dotted lines parallel to the longitudinal direction 116 of the web 110.

While the central region 120 in the present exemplary embodiment comprises one single material layer, both lateral edge regions 118 comprise two adjacent material layers. These double layer lateral edge regions 118 are formed by a 180° fold 119 of the single material layer extending from the central region 120 towards the lateral edge regions 118. The fold 119 forms the outer lateral edges of the sheets 112.

In the arrangement 30 of FIG. 3, the lateral edges of the flat web-type paper raw material 34 are folded inwardly by means of a lateral fold forming device 122 which is arranged between the second pair 52 of cooperating forming devices and the third pair 54 of cooperating forming devices. It has to be noted that in an embodiment of an arrangement having more than three pairs of cooperating forming devices, the lateral fold forming device preferably would be arranged between the last and the second last pair of cooperating forming devices.

As can be seen from FIGS. 22 and 23, the embossed protrusions 14 are also present in the lateral edge regions 118. The areas 124 of the embossed wrapping material 10, in which embossed protrusions 14 are present, are delimited in FIGS. 22 and 23 by dot and dash lines and have a generally rectangular outer shape. As can be seen from FIGS. 22 and 23, these areas 124 extend laterally outwardly up to the lateral edges 119 of the wrapping material 10. More specifically, in the present exemplary embodiment the width of the lateral edge regions 118 corresponds more or less to the width of a single protrusion 14a/b.

It is, however, to be understood that the width of the lateral edge region 118 may vary along the length of the embossed wrapping material 10, that is along the longitudinal direction 116, as is shown in FIG. 22. The reason is on the one hand that when the pre-undulated and at its lateral edges folded web-type paper raw material 34 enters the embossing device 48 with its embossing cylinders 70a/b the first creases 20 are created rather randomly by the material being pressed between the embossing cylinders 70a/b. This leads to a slightly non-uniform reduction of the width of the web-type paper raw material 34 and at the end to an embossed wrapping material 10 having lateral edges which are not absolutely straight, as is shown in FIG. 22. The reason is on the other hand that the folding process in the lateral edge folding device 122 may not uniformly which also contributes to a variable width of the double layer lateral edge regions 118 along the longitudinal direction 116.

The embossed wrapping material 10 in the present exemplary embodiment comprises a longitudinally extending strip shape region 126 which is free of protrusions 14a/b and which is delimited on both sides by the areas 124 having protrusions 14a/b. In the present exemplary embodiment, one sheet 112 of embossed wrapping material 10 comprises one single and, with reference to the lateral edge regions 118, centrally located strip shape region 126 extending from a leading edge (without reference sign, in FIGS. 22 and 23 the lower edge of a sheet 112) to a trailing edge (without reference sign, in FIGS. 22 and 23 the upper edge of a sheet 112). As can be seen from both FIGS. 22 and 23, the strip shape region 126 is delimited on both sides by the regions 124 having protrusions 14a/b. As further can be seen from the figures, the width of the strip shape region 126 corresponds approximately to at least the width of a protrusion 14a/b.

The presence of the strip shape region 126 has the following reason: when the flat web-type paper raw material 34 passes through the embossing device 48 with its embossing cylinders 70a/b, the material is received and deformed between the walls of the embossing cavities and the matching embossing protrusions of the embossing cylinders 70a/b. When the deformed material leaves the gap between the two embossing cylinders 70a/b, it has a certain tendency to stick to one of these cylinders 70a/b.

In order to prevent the embossed wrapping material 10 from sticking to the cylinders 70a/b, the arrangement 30 and specifically the embossing device 48 comprises a deflector means 128 (“separating means”) which is arranged adjacent the embossing cylinders 70a/b immediately downwardly of the embossing cylinders 70a/b. These deflector means 128 comes into sliding contact with the embossed wrapping material 10 and lifts the material off an embossing cylinder 70a/b, if the material 10 remains sticked to one of these cylinders 70a/b.

This deflector means 128 is arranged, seen in lateral direction of the embossed wrapping material 10, at the same location where the strip shape region 126 is located, that is where on the embossing cylinders 70a/b no embossing protrusions and matching cavities are present. Thus, the deflector means 128 cannot contact the wrapping material 10 in the areas 124 having the protrusions 14a/b, but rather and only in the strip shape region 126 being free of any protrusion 14a/b and therefore being relatively smooth and even. By consequence, the strip shape region 126 being free of protrusions 14a/b prevents the deflector means 128 from damaging the embossed wrapping material 10 by interfering with any embossed protrusions 14a/b.

As has already been mentioned, the lengthy web 110 of embossed wrapping material 10 comprises sheets 112 separated by perforation lines 114. These perforation lines 114 extend crosswise, that is orthogonally to the longitudinal direction 116. A perforation line 114 is formed by material bridges 130 and material slits 132. The material slits 132 are located between the material bridges 132. By consequence, along the length extension of a perforation line 114, material bridges 130 and material slits 132 alternate. In the present exemplary embodiment, the perforation line 114, that is the material slits 132, has been cut into the “final” embossed wrapping material 10 after the undulating and embossing steps.

In the present exemplary embodiment shown in FIGS. 22 and 23, the material slits 132 in the flat web-type raw material 34 (having no creases) are approximately 20 mm long, whereas the material bridges 130 are approximately 0.5 mm long. Therefore the length relation is at least 15, more preferably at least between 30-50, and the length of the material bridges 130 may be in the range of approximately 0.3-1.0 mm.

As can be seen from FIGS. 21 and 22, on both sides of a perforation line 114 there may be a crosswise extending strip shape region 134 which is free of any embossed protrusion 14a/b. In the present exemplary embodiment this strip shape region 134 extends from one lateral edge 119 of a sheet 112 to the opposite lateral edge 119 of the sheet 112. Seen in the direction of the strip shape region 134, the width of such a strip shape region 134 may be in the range of 10-40 mm, more preferably in the range of 20-30 mm.

In an aspect an embossed cushioning material for protecting an article comprises a plurality of embossed protrusions, and at least regionally the cushioning material comprises a plurality of first creases created during or prior to embossing the protrusions.

In an aspect the plurality of embossed protrusions comprises first protrusions extending in a first direction and second protrusions extending in a second direction, the second direction being opposite to the first direction.

In an aspect the plurality of embossed protrusions comprises only protrusions extending in a first direction.

In an aspect a height of at least some of the protrusions is in the range of 6-45 mm, more preferably in the range of 6-18 mm, still more preferably in the range of 8-11 mm.

In an aspect the embossed cushioning material at least regionally comprises a plurality of second creases created prior to embossing the protrusions, the second creases being essentially orthogonal to the first creases.

In an aspect the embossed protrusions have a maximum transverse dimension, when viewed from above, in the range of 4-100 mm, more preferably in the range of 4-14 mm, still more preferably in the range of 6-10 mm.

In an aspect the embossed cushioning material comprises first embossed protrusions having at least a first value of a dimension and second embossed protrusions having at least a second value of the same dimension, wherein the first value is different from the second value.

In an aspect the embossed cushioning material made from an initially flat paper material and wherein the grammage of the initially flat paper material is in the range of approximately 40-70 g/m², more preferably in the range of approximately 50-60 g/m².

In an aspect a density of embossed protrusions (number of protrusions per area) is in the range of approximately 3000-5000 1/m², more preferably in the range of approximately 3700-4400 1/m².

In an aspect a cross sectional shape, when viewed from the side, of at least some of the embossed protrusions is approximately half-circular, rectangular, or trapezoid.

In an aspect a cross sectional shape, when viewed from above, of at least some of the embossed protrusions is approximately circular, oval, or polygonal, specifically hexagonal.

In an aspect the embossed cushioning material comprises craft paper, preferably recycled craft paper.

In an aspect the invention relates to the use of an embossed cushioning material according to at least one of the preceding aspects for protectively wrapping an article.

In an aspect the invention relates to the use of an embossed cushioning material according to at least one of the preceding aspects for at least partially protectively accommodating an object, more preferably a food article, within a cavity provided by an embossed protrusion.

### LIST OF REFERENCE NUMERALS

10 embossed wrapping material
12 reference plane
14a/b embossed protrusions
16 first direction
18 second direction
20 first creases
22 longitudinal direction
24 lateral direction
25 second creases
26 height
28 maximum transverse dimension
30 arrangement
32 supply for supplying the paper material
34 flat web type paper raw material
36 roll of paper
38 transport path
40 tensioning unit
42 stationary cylindrical rollers of tensioning unit
44 vertically movable cylindrical roller
46 undulating device
48 embossing device
50 first pair of cooperating forming devices
52 second pair of cooperating forming devices
54 third pair of cooperating forming devices
56a/b forming devices of first pair
58a/b forming devices of second pair
60a/b forming devices of third pair
62 shaft
64 disk type portions
65 interstices between the disk type portions
66 undulated space
68 undulations
70a/b embossing cylinders
72 peripheral surface
74 food
76 raising bottom portion of embossed protrusion
78 flat top portion of embossed protrusion
80 first portion of raising bottom portion
82 intermediate second portion of raising bottom portion
84 rim
86 first ring shaped section
88 second ring shaped section
90 embossing element
91 sleeve
92 straight cylindrical outer surface portion
94 curved cylindrical outer surface portion
96 cylindrical recess
98 screw
100 screw head
102 flat top surface
104 curved edge portion
106 flat outer edge portion
108 recess
110 lengthy web
112 sheets
114 perforation line
116 longitudinal direction
118 lateral edge regions
120 central region
122 lateral edge forming device
124 areas with protrusions
126 strip shape region
128 deflector means
130 material bridges
132 material slits
134 crosswise extending strip shape region

1. An embossed wrapping material for protectively cushioning an article, the wrapping material comprising a plurality of embossed protrusions, wherein the plurality of embossed protrusions comprises first protrusions extending in a first direction and second protrusions extending in a second direction, the second direction being opposite to the first direction, wherein at least regionally the cushioning material comprises a plurality of first creases created during or prior to embossing the protrusions.

2. The embossed wrapping material of claim 1, wherein at least one lateral edge region comprises a higher number of material layers than a central region.

3. The embossed wrapping material of claim 2, wherein the lateral edge region is formed by at least one 180° fold of the material layer(s) extending from the central region.

4. The embossed wrapping material of claim 2, wherein a width of the lateral edge region corresponds to at least the width of a protrusion.

5. The embossed wrapping material of claim 2, wherein the lateral edge region also comprises protrusions.

6. The embossed wrapping material of claim 1, wherein it comprises at least one longitudinally extending strip shape region which is free of protrusions and which is delimited on both sides by regions with protrusions.

7. The embossed wrapping material of claim 6, wherein the width of the strip shape region corresponds to at least the width of a protrusion.

8. The embossed wrapping material of claim 1, wherein it comprises crosswise extending perforation lines, the perforation lines being formed by material bridges alternating with material slits, at least some of the material slits being at least 15 times longer than at least some of the material bridges, more preferably at least between 30-50 times longer than the material bridges.

9. The embossed wrapping material of claim 8, wherein the length of the material bridges is in the range of approx. 0.3-1.0 mm, preferably approx. 0.5 mm.

10. The embossed wrapping material of claim 8, wherein at least on one side of a perforation line and adjacent a perforation line there is a crosswise extending strip shape region free of protrusions.

11. The embossed wrapping material of claim 1, wherein a height of at least some of the protrusions is in the range of 4-45 mm, more preferably in the range of 4-18 mm, still more preferably in the range of 4-7 mm.

12. The embossed wrapping material of claim 1, wherein it at least regionally comprises a plurality of second creases created prior to embossing the protrusions, the second creases being essentially orthogonal to the first creases.

13. The embossed wrapping material of claim 1, wherein the embossed protrusions have a maximum transverse dimension, when viewed from above, in the range of 4-100 mm, more preferably in the range of 10-18 mm, still more preferably in the range of 12-16 mm.

14. The embossed wrapping material of claim 1, wherein it comprises first embossed protrusions having at least a first value of a dimension and second embossed protrusions having at least a second value of the same dimension, wherein the first value is different from the second value.

15. The embossed wrapping material of claim 1, wherein it is made from an initially flat paper material and wherein the grammage of the initially flat paper material is in the range of approximately 40-80 g/m², more preferably in the range of approximately 60-70 g/m².

16. The embossed wrapping material of claim 1, wherein a density of embossed protrusions (number of protrusions per area) is in the range of approximately 3000-6000 1/m², more preferably in the range of approximately 400-5500 1/m², still more preferably in the range of approximately 4300-5300 1/m².

17. The embossed wrapping material of claim 1, wherein a cross sectional shape, when viewed from the side, of at least some of the embossed protrusions is approximately half-circular, rectangular, trapezoid, or dome-shaped with a raising bottom portion and an essentially flat top portion.

18. The embossed wrapping material of claim 17, wherein the raising bottom portion of the dome-shaped protrusions comprises a first portion adjacent a reference plane of the wrapping material and an intermediate second portion arranged between the first portion and the top portion, wherein the slope suddenly changes at the transition of the first portion to the second portion.

19. The embossed wrapping material of claim 1, wherein a cross sectional shape, when viewed from above, of at least some of the embossed protrusions is approximately circular, oval, or polygonal, specifically hexagonal.

20. The embossed wrapping material of claim 1, wherein it comprises craft paper, preferably recycled craft paper.

21. Use of an embossed wrapping material according to claim 1 for protectively wrapping an article.

22. Use of an embossed wrapping material according to claim 1 for accommodating an object, more preferably a food article, within a cavity provided by an embossed protrusion.
